(19) United States
(12) Patent Application Publication
(10) Pub. No.: US 2019/0026015 A1
(43) Pub. Date: Jan. 24, 2019

(54) System and method for inserting and editing multimedia contents into a video

(71) Applicant: Victor Lee, Mississauga (CA)

(72) Inventor: Victor Lee, Mississauga (CA)

(21) Appl. No.: 15/657,614

(22) Filed: Jul. 24, 2017

(51) Int. Cl. G06F 3/0485; G06F 3/0488; G11B 27/036; H04N 5/765

(52) U.S. Cl. CPC G06F 3/04855; H04N 5/765; G11B 27/036; G06F 3/04883

(57) ABSTRACT

Some embodiments of the invention provide a computer based method of editing video, allowing users to add multimedia objects such as sound effect, text, stickers, animation, and template to a specific point in a timeline of the video. In some embodiments, the timeline of the video is represented by a simple scroll bar with a control play button, which allows a user to drag the control play button to a specific point on the timeline. This enables a user to pinpoint a specific frame within a video to edit. In some embodiments, a multimedia panel allows a user to select specific multimedia objects to add to the frame, with further manipulation. A mechanism to store these multimedia objects associated with the selected frame is defined in this invention. In some embodiments, frames with multimedia objects added will have indicators shown on the scroll bar, allowing the user to fast forward to that frame and further edit the frame.

### BACKGROUND

With the proliferation of mobile devices and availability of wireless Internet, users will want to incorporate multimedia to edit videos that describe their lives. Users are able to record videos on their phone with ease to share with their friends. Editing their video by adding stickers, animations, text, and sound effects will make the video richer and more enhanced.

One of the principal barriers of editing videos on one's phone is the limitation of the screen. Users simply do not have the luxury of a full monitor, mouse and pointers, or a complex software interface to enable the complex operations of adding rich media contents. For example, how would a user add text and sound effects at a certain point within a video without resorting to complex interface that is too large to fit on a mobile device screen? There exists a need for a method and interface that can simplify the video editing operations into very simple steps, allowing the user to add enhancements to mobile video.

### PRIOR ART

Video editing has increased in popularity since the invention of camcorders in the 1970s and early 1980s. With the proliferation of web technologies and software in the 90s, users are able to upload their personal videos to a computer and edit them via a complex computer based interface or web layout, with a large number of parameters, buttons, and features. These computer based video editing software are complex and require a significant amount of time to edit each video.

With the proliferation of mobile devices with cameras and video recording capabilities, the need for video editing and customization becomes paramount. Whereas the user can now share their video to social media, the need to turn their video into rich media content with added music, sound effects, animation, and stickers become important. While users can conveniently record their videos, there is no efficient way to edit such videos on a small mobile screen. The prior complex software based video editing methods would not work because it is impractical to fit all the buttons and layouts in the small mobile screen. Uploading their personal videos into a computer system and spending hours editing such videos in complex software is no longer appealing to people.

There has emerged a class of rudimentary mobile video software that performs limited functions. The most typical of these functions is to trim a video or cut out certain frames. However, this is limited because users are not able to add complex data or Multimedia Objects, such as sound, animations, stickers, and templates into the video to further customize it. There emerges another class of mobile software, enabling users to add “filters,” captions, or stickers into the video. The limitation of this software is that these “filters” persist throughout the video and the level of customization allowed for the users is severely limited.

For example, assume that a user films a video of riding a roller coaster and desires to edit this video with rich data and multimedia contents in order to enhance it. The traditional “filters” approach allows users to change the brightness or add a sticker or filters on the video, which persists throughout the video. However, users are severely restricted on how they can customize the video. For example, users will not be able to add a screaming sound at the moment when the roller coaster dives down, or a “Woah” animated text when the roller coaster hits the bottom.

There exists a need to allow users to pinpoint specific moments in the video to edit and add rich multimedia content. Such methods must be embedded into an extremely simple tool on mobile devices without the cluttering of complex buttons and features, and enable everything to fit into a small mobile device screen.

### SUMMARY OF INVENTION

Provided herein are methods and systems for editing a video clip on mobile devices, using a single Scroll Bar (210) that represents the timeline of the clip and provides a single control, where Multimedia Objects such as sound bites, stickers, animation, drawings , and text can be added at any point within the timeline, using the Scroll Bar to pinpoint a specific frame of the video clip.

The clip may be a video clip, an audio clip, a multimedia clip, a clip containing advertisements, a clip enabling the user to interact. This video clip may be created by the Image Sensors (115) from the mobile device or retrieved from the video library storage (114). The clip may contain sound, in which the corresponding sound files are retrieved from the sound library storage (113).

The Scroll Bar (210) is used to control the clip, enabling the user to pinpoint to a specific time in a timeline of the clip. User can fast forward or rewind at different speeds by simply dragging forward or backward on the Scroll Bar Play button (212) on the Scroll Bar with different speeds. The clip will play forward or background with different speed, depending on where the user drags the scroll bar and pinpoints the specific frame.

The Scroll Bar is connected to the Touch Controller (118), which receives haptics signals from the Touch Display when a user touches and manipulates the Scroll Bar (210) on the Display (116). The Scroll bar Play Button (212) can be dragged forward and backward along the Bar (214). This will translate to signals to request to move the frames of the video clip in rewind or fast forward mode. A haptic contact release means that the Scroll Bar Play button (212) will pause at that specific frame. At this point, the user can access the Multimedia Objects such as Sound Bites (312), Stickers (314) or Animation (316) from the multimedia storage (120), and Text (317) to apply to the specific frame of the video clip.

Once a user adds the Multimedia Objects on the specific frame, an Indicator (216) will be displayed on the Scroll Bar (210) to indicate on that specific frame that a multimedia object has been added. Different Indicators will correspond to different Multimedia Objects, including Sound bites (217), Stickers (218), Animation (220) and Text (219). The user can press these Indicators (216) on the Scroll Bar (210) and instantly fast forward to that specific frame of the video clip. This allows the user to perform fast editing across multiple elements on the Scroll Bar.

When a user plays the entire video clip from the start and the video clip reaches the frame where the user added the Multimedia Objects, it will display the Multimedia Objects (380) on those specific frames.

### BRIEF DESCRIPTION OF THE DRAWINGS

FIG. 1 illustrates the key components of a mobile device implementing the method according to the invention.

FIG. 2A illustrates the processing operation of loading specific frames of a said video clip, according to one embodiment of the invention

FIG. 2B illustrates the processing operation of the scroll bar controls, according to one embodiment of the invention

FIG. 3 illustrates the processing operation of storing multimedia objects associated with a said frame, according to one embodiment of the invention

FIG. 4 illustrates the processing operation of a user choosing different multimedia objects, according to one embodiment of the invention

FIG. 5A shows a visual frame of a mobile device displaying multimedia object types, according to one embodiment of the invention.

FIG. 5B shows a visual frame of a mobile device displaying a multimedia objects list, according to one embodiment of the invention.

FIG. 6A illustrates the processing operation of selecting and adding a multimedia object to a said frame, according to one embodiment of the invention.

FIG. 6B shows a visual frame of a mobile device displaying a multimedia objects list and scroll bar, according to one embodiment of the invention.

FIG. 6C shows a visual frame of a mobile device displaying a scroll bar with indicator, after multimedia objects are added to the video, according to one embodiment of the invention.

FIG. 7A illustrates the processing operation of playing the video containing multimedia objects and displaying such multimedia objects, according to an embodiment of the invention.

FIG. 7B illustrates the processing operation of retrieving associated multimedia objects and displaying them when the video is playing, according to an embodiment of the invention.

FIG. 7C illustrates the processing operation when an indicator in the scroll bar is being pressed and the video is being fast forwarded to the said frame, according to an embodiment of the invention

FIG. 8A illustrates the processing operation of adding a multimedia object to a said frame, according to another embodiment of the invention.

FIG. 8B illustrates the processing operation when an indicator in the scroll bar is being pressed and the video is being fast forwarded to the said frame, according to another embodiment of the invention

### DETAILED DESCRIPTION OF THE INVENTION

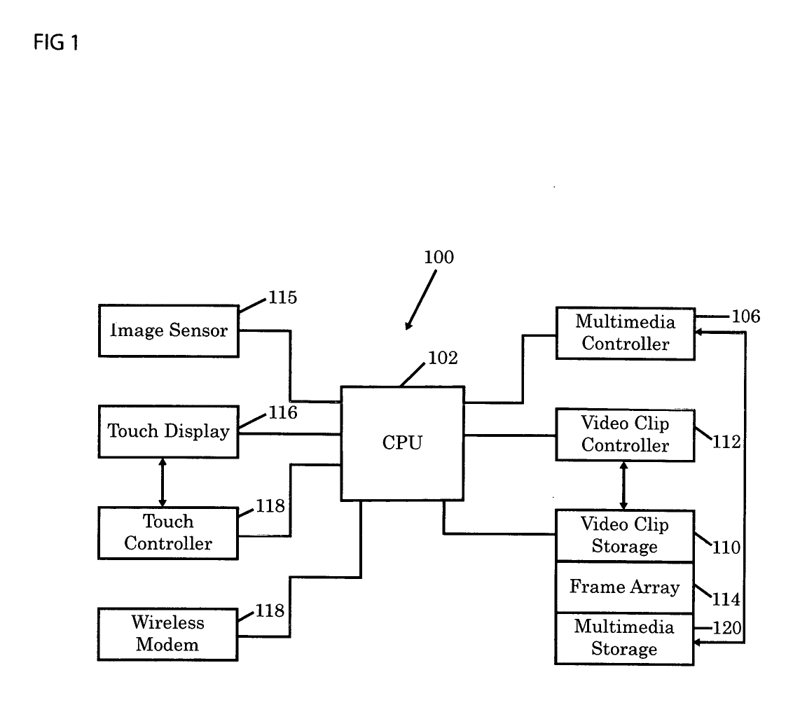

FIG. 1 illustrates an electronic device (100) implementing operations of the invention. In one embodiment, the electronic device contain a CPU (102) with communication to various parts of the hardware system, including Image Sensor (115), Touch Display (116), Touch Controller (118), Multimedia Controller (106), Multimedia Storage (108), Video Clip Storage (110), Video Clip Controller (112). Multimedia Storage (108) and Video Clip Storage (110) comprising of flash memory and random access memory to store the Multimedia Objects such as sound files, animation GIF files, video, images, and video clips for editing. These video and multimedia files are used to implement operations of the invention. The Video Clip Controller (106) and the Multimedia Controller (112) include executable instructions to manipulate the videos into frames or to fast forward and rewind backwards on a video and merge the Multimedia Objects into the video clip. The Touch Display (116) receives haptic signals such as touch, drag, and hold to indicate the Processor (102) to different operations. The Touch Controller (118) contains programming instructions to execute such operations.

The electronic device (100) is coupled with an Image Sensor (115) to capture video and store the video into Video Clip Storage (110). Video Clip Controller (112) can also retrieve the video clip previously recorded from Video Clip Storage (110) and use it for this operation.

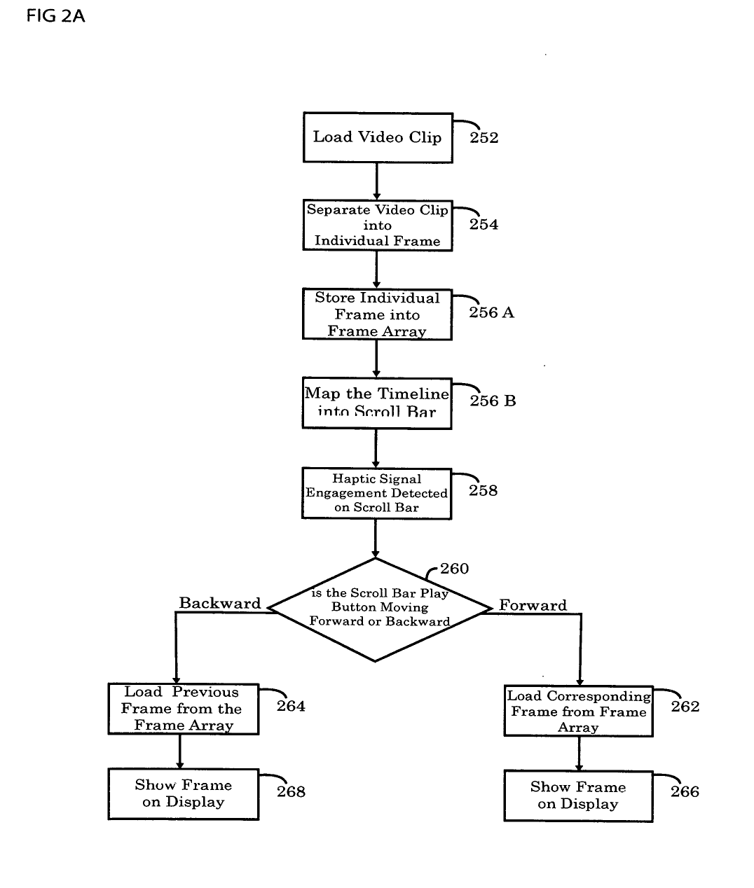

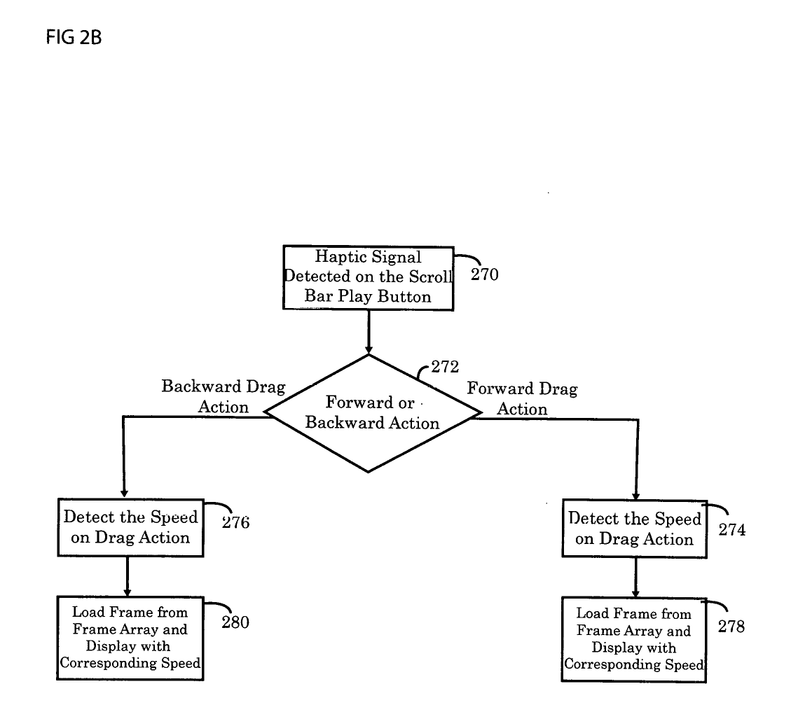

FIG. 2 illustrates processing operations in the implementation of this invention. Initially the Video Clip (220) is loaded from Video Clip Storage (110) under the operation 252. The Video Clip (220) may be captured by the Image Sensor (115), immediately loaded into the Video Clip Storage (110), or retrieved from the Video Clip Storage (110) of a previously captured video clip.

Returning to FIG. 2, haptic contact engagement is identified on the Scroll Bar Play Button (212), in the operation 258. This occurs when the user touches the Scroll Bar Play Button (212) and begins to drag it. The drag movement of the haptic contact is identified to indicate whether the user desires to drag forward or backward on the Scroll Bar (210), in the operation 260. As the user drags forward on the Scroll Bar (210), the Video Clip Controller (112) will load the corresponding frames from the Frame Array (114), in the operation 262. And if the backward drag motion is detected, the previous frames will be loaded from the Frame Array (114), in the operation 264. It will then display those frames continuously on the Display (116). Frames can continue to be fetched from the Frames Array (114) and displayed on screen in response to persistent haptic contact and drag on the display, as in the operation 266 and 268.

The speed of the drag on the haptic signal will also be identified, in which the Video Clip Controller (112) will determine how fast to load and display the next frame from the Frame Array (114). Thus, the user can drag forward and backward on the Scroll Bar to continuously fast forward or rewind on the Video Clip (220) by displaying the corresponding frame on the Display.

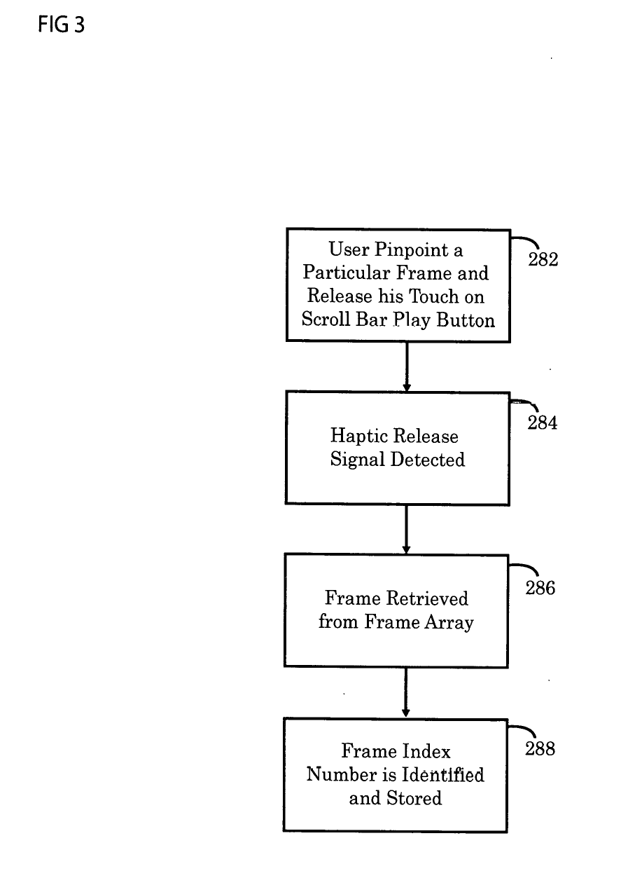

According to FIG. 3, the haptic release signal is identified in 302. The location of the Scroll Bar Play Button (212) on the Scroll Bar (214) corresponds to the last frame being retrieved from the Frame Array (114) and display on screen. This frame index number corresponding to the frame within the Frame Array (114) is identified and stored.

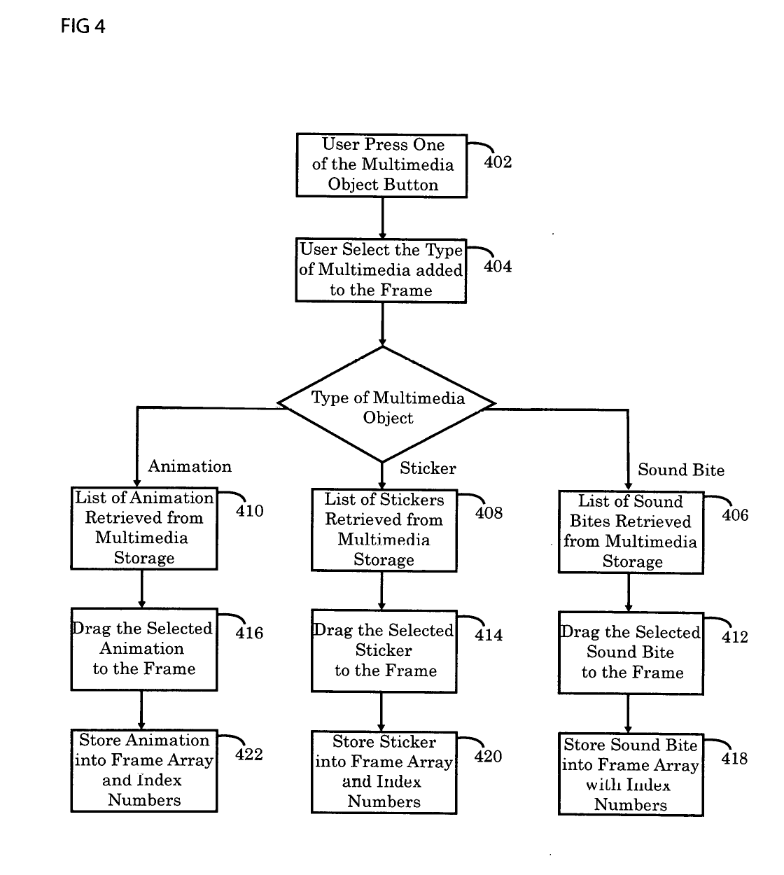

FIG. 4 describes the operation for adding Multimedia Objects (380) to the frame. Diagram 300 shows the editing screen with the Multimedia Objects displayed as buttons. In this embodiment, Multimedia Objects are represented by Sound Bite button (312), Sticker button (314) and Animation button (315). In other embodiments of the invention, other Multimedia Objects may be included.

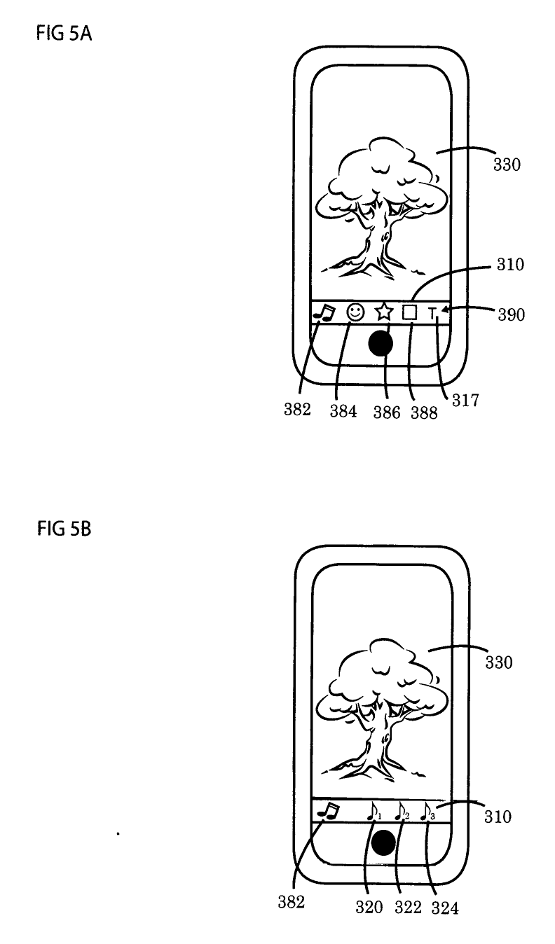

FIG. 5A shows how a user can select the types of Multimedia object 380. The types of Multimedia Objects 380 may include Sound bites (382), user Pre-recorded Sounds (384), Stickers (386), Animation (388) or Background templates (390) and Text (389).

The stickers, animation, sound bites and templates are arranged in terms of icons on the Multimedia Tray area (310) on screen. There is a main Frame Area 330 which displays either a video or photo taken by the user using the Image Sensor 115. The video or photo taken is subject to be edited, such that the user can add the Multimedia Objects 380, according to this invention.

FIG. 5B shows the interface on how a user can select a list of specific Multimedia Objects 380, such as a specific sticker and apply to a frame. When a user presses the type of the multimedia object buttons located in the Multimedia Tray area (310), a list of corresponding Multimedia Objects will be shown on screen. For example, a user may select Sound Bite (382) by pressing on the Sound Bite button (312), and a list of sound bites will be shown (320, 322, 324). User can now drag a sound bite icon (320) into the frame in the main Frame Area (330). Haptic signal is detected to identify a drag motion, and the sound bite will be added to the frame. At this point, the Video Clip Controller (112) will store the sound file into the Video Frame Array (114), placing an indicator/flag at the frame index number. When the full Video Clip (220) is played, and when the video playback reaches the corresponding frame, the frame number with the flag will be detected, which will trigger the sound bites to play simultaneously at that frame.

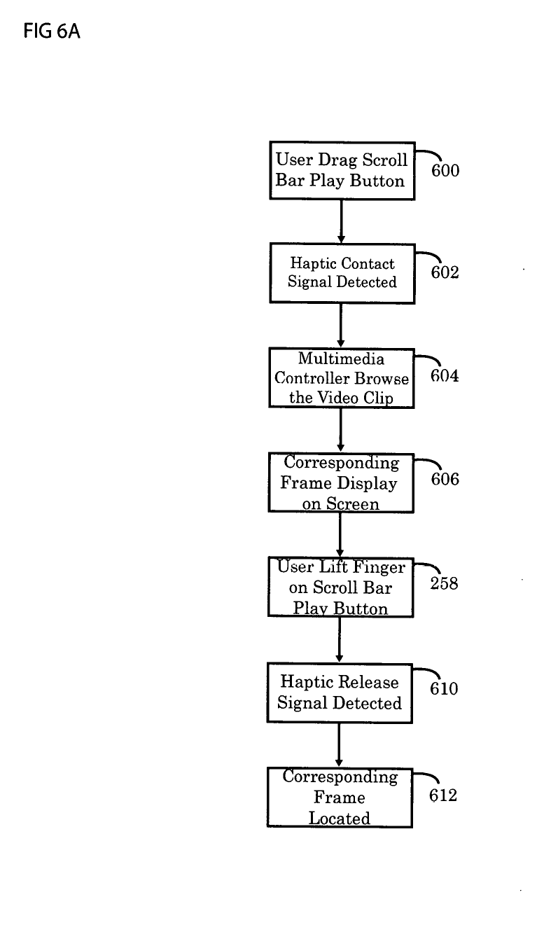

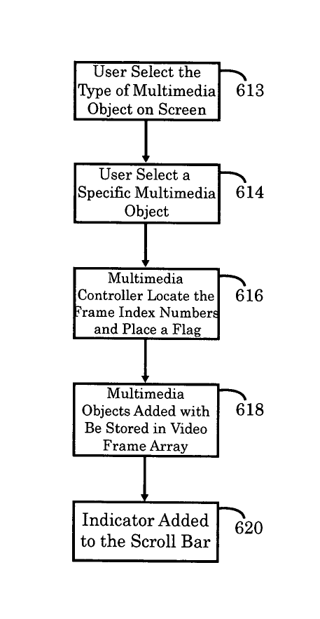

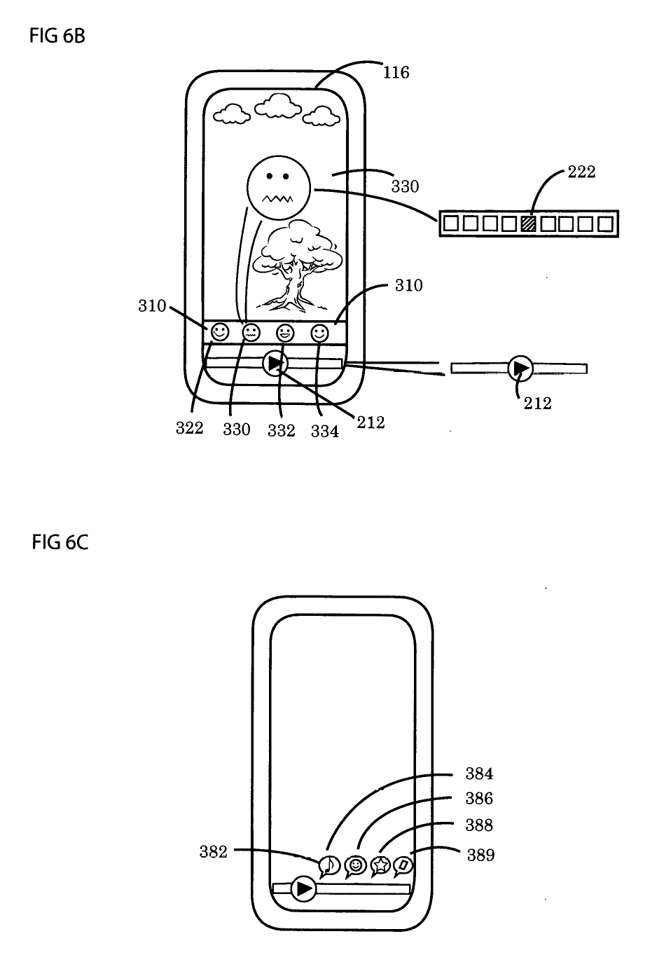

FIG. 6A shows the operation in which the user can locate a specific frame of a video using the Scroll Bar 210 and add Multimedia object 380 to that frame. A user drags the Scroll Bar Play Button (212) to a specific time in the timeline, and adds a sticker to that frame, according to operation 600. When a user starts dragging on the Scroll Bar Play Button (212), the haptic contact signal is detected for this drag action as in 602, and the Multimedia controller (108) will browse through the Video Clip (220), as illustrated in 604. During this time, the corresponding frame will be shown on the Display (116) continuously, as illustrated in 606. When a user reaches his desired frame, he will stop by lifting his finger on the Scroll Bar Play Button (212), in 608. At this point, haptic release signal will be detected, as in 610. The corresponding frame (222) is then located within the Video Clip (220), and stored in the Frame Array 114 with the corresponding Frame Index Number (290). This final frame (212) chosen by the user will be shown on the Display (116) and the main Frame Area (330).

Once a user locates the frame, he can select the type of Multimedia Objects 380 on screen, as illustrated in 612. He can start adding his desired stickers or other Multimedia Objects (380) onto the frame. Other Multimedia Objects (380) can be sound bites (382), user pre-recorded sounds (384), stickers (386), animation (388), Text (389) or background templates (390). They may all be added to the frame as stickers (330) in the following procedures.

A user can then select the specific Multimedia object and add it into the frame, as in operation 614. A user first presses the a Multimedia Object Button (322) located under the Multimedia Tray area (310). For example, a user may press the Sticker button (316) and a list of stickers will be shown (330, 332, 334). The user can now choose the desired sticker from the Multimedia Tray area (310). He can accomplish this by dragging a sticker icon (330, 332 or 334) into the frame in the main Frame Area (330), or simply by tabbing the chosen sticker. As shown on operation 616, Multimedia Controller (108) will locate the frame index number 290 from the Video Frame Array (114), placing a flag with the frame index number (290), as in 618. The sticker (330, 332 or 334) will then be stored alongside the frame with that frame index number 290. The same steps apply if the user is adding other Multimedia Objects (380). FIG. 6C shows how the screen layout where an Indicator (382) will be added when a particular frame is being edited. An Indicator (382) will be placed on the Scroll Bar (210), as illustrated in operation 620. Different indicators will be used for different Multimedia Objects, such as sound bites (384), stickers (386), animation (388), template (389), will be placed on the Scroll Bar (210) time line. The function of these Indicators is to allow the user to quickly locate the frame in which the Multimedia Objects (380) are added such that he can edit them quickly. These operation will be shown on the latter part of this invention.

As an embodiment of this invention, a user can further manipulate the stickers or animation being added to the Video Clip (220). For instance, with stickers and animation, the user can enlarge, rotate, or move the Multimedia object to any position of the Display (116).

User can add multiple Multimedia Objects (380) such as multiple stickers across the timeline. In that case, multiple Indicators (382) will be shown on the Scroll Bar (210) timeline corresponding to the multiple Multimedia Objects (380) that the user has added along the timeline.

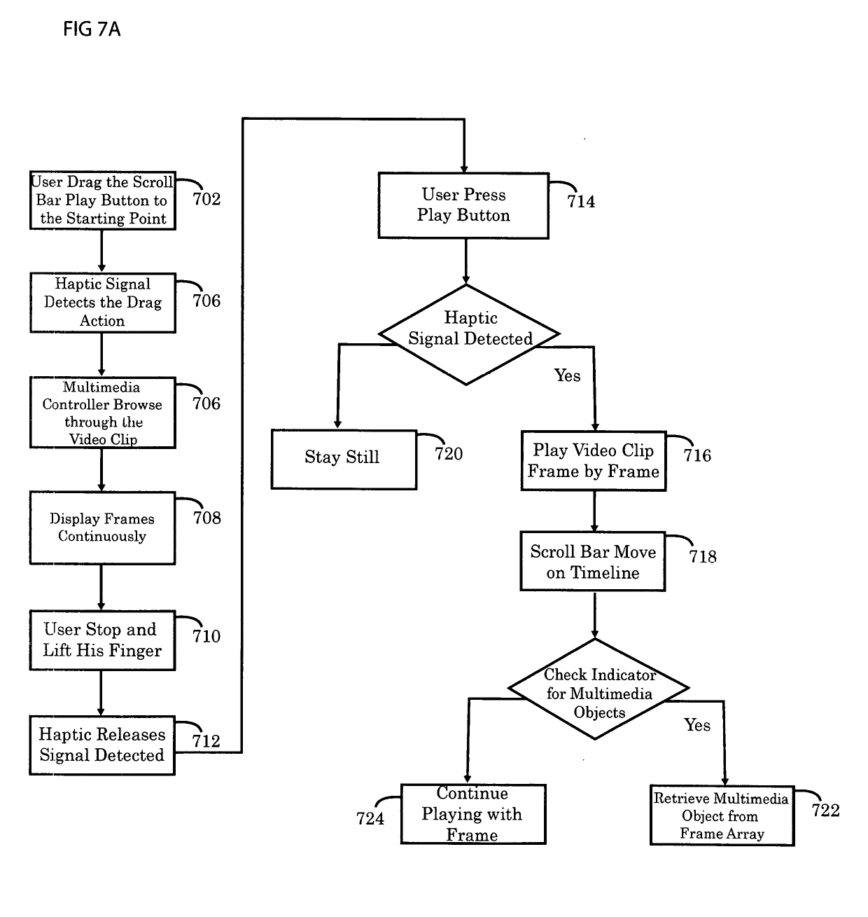

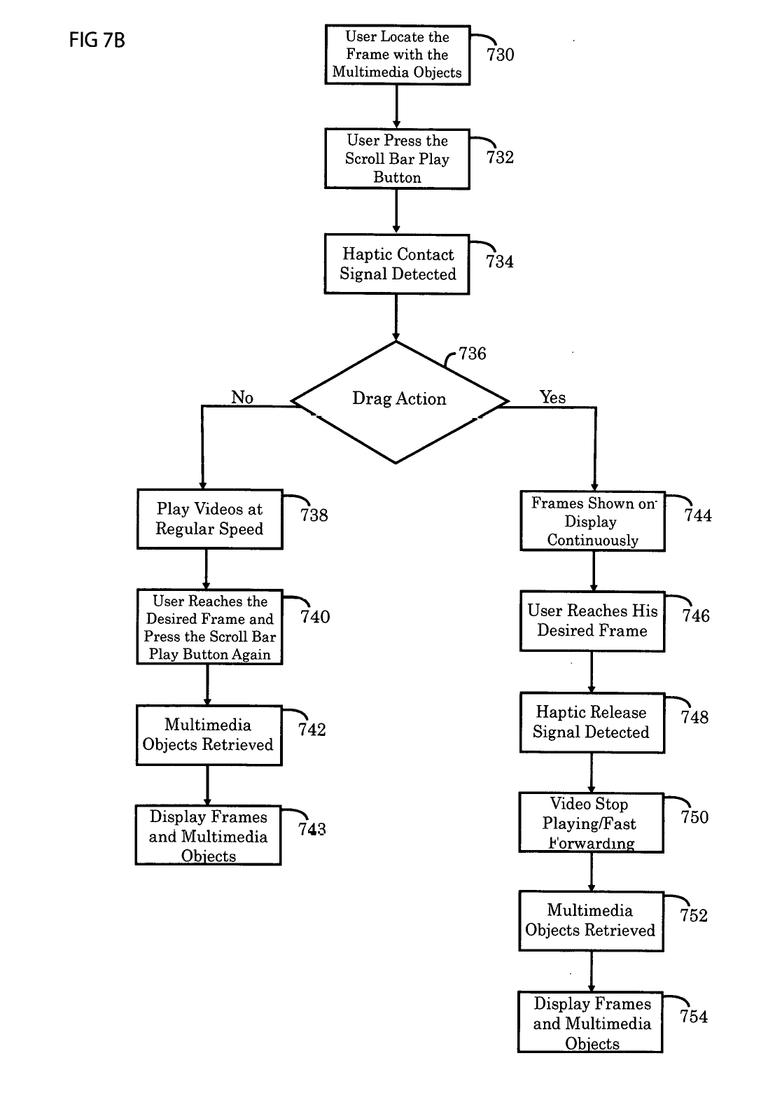

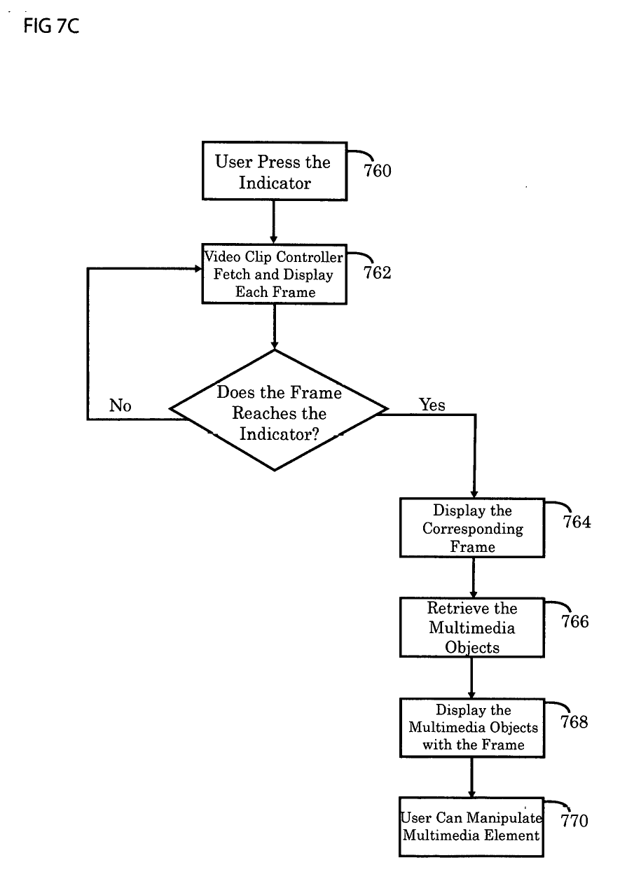

FIG. 7A illustrates the operation of playing the Multimedia Objects 380 in the edited video, using the Scroll Bar 210. As an embodiment of this invention, a user can play the entire video to view his edited video. (i.e. with Multimedia Objects such as stickers added to his video). He will first drag the Scroll Bar Play Button 212 to the beginning of the timeline, or any point in the timeline, as shown on operation 702. In this case, the haptic contact signal is detected for this drag action in operation 704 and the Multimedia Controller 390 will browse through the Video Clip (220), rewinding it, in operation 706. During this time, the corresponding frame will be shown on the Display (116) continuously, only backwards in rewind action, as shown in 708. When a user reaches his desired frame, he will stop by lifting his finger on the Scroll Bar Play Button (212), indicated by operation 710. At this point, the haptic release signal will be detected, and the corresponding frame (222) will be shown on the Display (116), as in operation 712. The user can then press the Scroll Bar Play Button 212 again to play the video, either from the beginning or at any point in the timeline that he left off, as in operation 714. Haptic signal is detected for the touch action, and the Video Clip (220) will be played, frame by frame, as in 716. As the video is played, the Scroll Bar Play Button will move forward in the timeline, corresponding to the frame being played on the Display (116). At this point, the Video Frame Array (114) will be browsed through frame by frame, checking if there is a flag/indicator of any Multimedia Objects (380) being added to that frame. Once it detects a flag/indicator, the Multimedia Controller (390) will retrieve the stored Multimedia Objects 380 (such as stickers 330, sound bites 382, user pre-recorded sound 384, animation 386 or background templates 388), and display them alongside the frame on the Display (116), as in operation 722. If Multimedia Controller 390 did not detect the flag/indicator, it will continue to play the next frame from the Frame Array (114).

FIG. 6D shows an embodiment of this invention, the design interface on how a user edits the Multimedia Objects (380) within the Video Clip (220). FIG. 7B shows the operation in editing the Multimedia Objects (380) on the timeline using the Scroll Bar 210. In operation 730, a user first locates the frame containing the Multimedia object 380 as illustrated in operations in FIG. 7A. Since there is an Indicator 382 located in the Scroll Bar 210, it is convenient for the user to rewind or fast forward to the particular frame with the Multimedia object 380, using the Scroll Bar Play Button 212. In this operation, the user can either press or drag the Scroll Bar Play Button (212) to browse through the Video Clip (220). In operation 732, a user presses the Scroll Bar Play Button (212). Haptic signal is detected, and the Video Clip (220) will be played, as in operation 734. Touch controller (118) will further distinguish between a drag action or a touch action, as in 736. A touch action on the Scroll Bar Play Button 212 indicates that the user desires to play the video with regular speed and can pinpoint a specific frame by stopping the video. A drag action on the Scroll Bar Play Button 212 indicates that the user desires to fast forward (or rewind) with various speed, such that he can pinpoint the specific frame faster.

Operation 736 shows how a Multimedia Object may be retrieved when a user access an edited frame, according to one embodiment of the invention. First, the user press the Scroll Bar Play Button 212; a touch action is detected by the Touch Controller (118), indicating a Play action. The Scroll Bar Play Button (212) will move along the timeline as the Video Clip (220) is played, displaying the frames on the Display (116). The user then reaches the frame he desires to edit, he will stop playing the video. At this point, he may press the Scroll Bar Play Button (212) again, to signal a stop action, as in operation 738. Haptic contact signal is detected, indicating a Stop action, as in operation 740. The Video Clip (220) will stop playing at the desired frame the user indicates. At this point, if the frame is previously edited with a Multimedia Object (380), this Multimedia Object (380) will be retrieved from the Frame Array 114 and show on the Display (116) along side with the frame, as shown on 742. At this point, the user is ready to edit that frame and the Multimedia Objects (380) in it.

Operation 744 shows an alternate way to locate a particular frame on the Video Clip (220) to edit, according to another embodiment of the invention. First, a user will drag the Scroll Bar Play Button to the desired frame to edit. Touch Controller 118 detects a haptic drag action, indicating that the user desires to fast forward to the particular frame quickly. Frames of the Video Clip (220) will be shown on the Display continuously as the user drags forward or backward. The speed of fast forward/rewind corresponds to the speed of the drag action. As the user reaches the point on the timeline or slide which he desires to edit, or at the point shown with the Indicator (382), he can release his finger, as indicated in operation 746. Haptic contact release signal will be detected in 748, indicating a stop in playing/fast forwarding/rewinding the Video Clip 220, as illustrated in operation 750. At this point, the corresponding frame will be shown on the Display (116). The Multimedia Objects (380) will be retrieved and shown on the Display (116) along side with the frame. The user is ready to edit that frame and the Multimedia Objects (380) in it.

FIG. 6F shows an interface design using alternative way to locate a particular frame on the Video Clip (220) to edit, by pressing the Indicator (382) to fast forward to the said frame, according to another embodiment of the invention. FIG. 7C shows such operation. A user can press the Indicator (382) button along the Scroll Bar (210), as indicated on operation 760. The Video Clip Controller (112) will then fast forward to that particular frame, by fetching each frame from the Frame Array (114), as shown on operation 762. Frames will be retrieved from the Video Frame Array (114) and shown on the Display continuously. During the process, the fast forward (or backward) action will be shown on the Display (116), so that the user will see the rewinding/fast forwarding, as shown in the operation 764. When the frame with the Indicator is shown on the Display, the Multimedia controller (390) will also fetch the Multimedia Objects (380) and display them along side the frame, as indicated in operations 766 and 768.

When a user reaches the frame he desires to edit, he can manipulate the Multimedia Objects (380) on the frame as shown in operation 770, according to one embodiment of the invention. This includes deleting the Multimedia Objects (380) by dragging them to the edge, as well as resizing, rotating, or moving them around on the screen.

If a user deletes all the Multimedia Objects (380) on the frame, the Indicator (382) of that frame will disappear on the Scroll Bar (210).

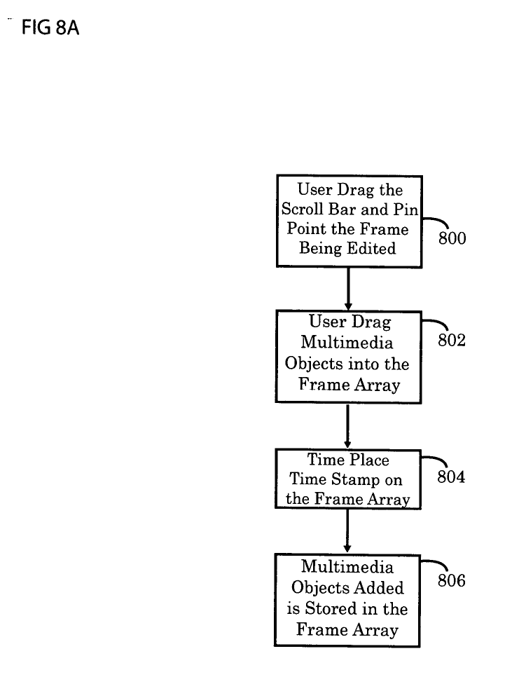

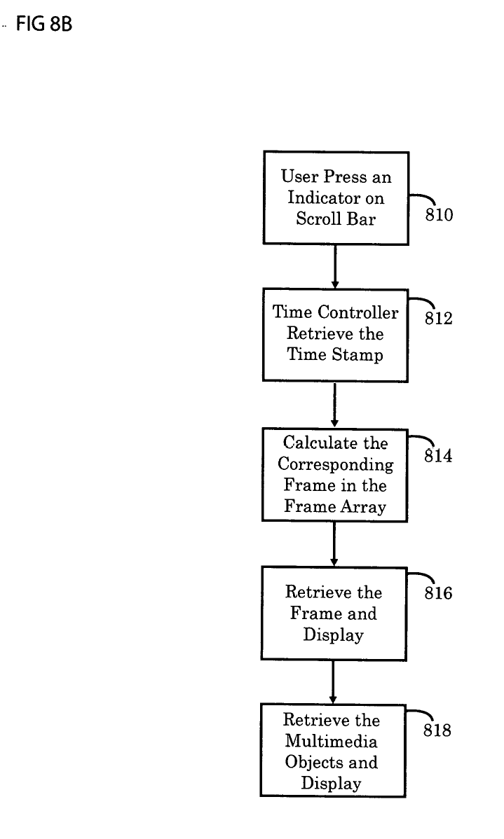

In another implementation of the invention in FIG. 8A, the operation shows the mechanism behind adding a Multimedia object onto a frame. A user first drags the scroll bar to a certain frame that he wants to edit and add Multimedia Objects (380), as indicated in operation 800. In operation 802, the user begins to edit the frame by dragging the Multimedia Objects (380) onto the main Frame Area 330. At this point, a user can press the Sticker Button (332) located under the Multimedia Tray area (310) by dragging the sticker icon to the main area.

A Timer Controller (115) will place a timestamp on the Frame Array (114) at which the Multimedia object is added, as indicated by operation 804. This timestamp is stored within the Frame Array (114). This timestamp indicates the time within the video in which the Multimedia object is added. For example, if a Video Clip (220) is 8 seconds and a sticker is added to a frame, which is 3 seconds on the video, a timestamp that is equivalent to 3 seconds will be stored in the Frame Array (114). An Indicator (382) is added to the Scroll Bar (210) along the timeline. The corresponding Multimedia object (380) will be stored in the Frame Array (114), as indicated by operation 806.

As an embodiment of the invention, FIG. 8B demonstrates the operation of retrieving a frame and the corresponding Multimedia Objects using the timestamp approach of this invention.

The user can press the Indicator (382) on the Scroll Bar 210 to fast forward to the specific frame he desires to edit, as indicated in operation 810. The Timer Controller (115) retrieves the corresponding timestamp, as indicated in operation 812. The Timer Controller 115 then uses the timestamp to calculate the corresponding frame within the Frame Array (114) that the time of the video belongs to, as indicated by operation 814. This frame is retrieved from the Frame Array and shown on the Display 116, indicated by the operation 816. The corresponding Multimedia Objects 380 is also retrieved and displayed alongside the frame, as indicated by operation 818.

The invention claimed is:

1. An electronic device, comprising:
Digital image sensors to capture visual media;
a display to present the visual media from the digital image sensors;
a touch controller to identify haptic contact engagement, haptic contact release, haptic contact drag action, haptic contact speed on the display.
a video clip controller to separate the said video into individual frames and store them into the frame array;
a video clip controller to browse and display frames of a video based on the haptic contact drag action, haptic contact engagement and haptic contact release.
a multimedia controller to add multimedia objects to specified frames determined by the video clip controller.

2. The electronic device of claim 1 wherein the video clip controller presents a scroll bar tool on the display to receive haptic contact engagement, haptic drag action, and haptic contact release.

3. The electronic device of claim 1 wherein the video clip controller displays the specific frames on the display continuously, based on haptic drag action, or haptic contact signal applied to the scroll bar.

4. The electronic device of claim 1 wherein the video clip controller load and displays specific frames, chosen by the user, based on haptic release signal applied to the scroll bar.

5. The electronic device of claim 4 wherein the multimedia controller inserts multimedia objects in the form of animation onto the said frame.

6. The electronic device of claim 4 wherein the multimedia controller inserts multimedia object in the form of text onto the said frame.

7. The electronic device of claim 4 wherein the multimedia controller inserts multimedia object in the form of sound effects onto the said frame.

8. The electronic device of claim 4 wherein the multimedia controller establishes an association between the multimedia object being inserted and the said frame.

9. The electronic device of claim 9 wherein the multimedia controller stores the chosen multimedia object and the said frame into the frame array.

10. A non-transcient computer readable storage medium, comprising executable instructions to:
process haptic contact signals from a display;
record a video;
separate a video into individual frame and store each frame into a Frame Array;
browse and display each frame of the video forward based on haptic contact drag signal forward, in order for the user to locate a specific frame to be edited;
browse and display each frame of the video backward based on haptic contact drag signal backward, in order for the user to locate a specific frame to be edited;
insert a multimedia object into a said frame chosen by a user by a drag haptic contact signal from the multimedia object area into the main frame area;
play the video based on a haptic contact signal play and display the said multimedia objects being added to a specific frame when the said frame is played;

11. The non-transcient computer readable storage medium of claim 10 wherein the haptic contact signal forward is a specific gesture performed on the display.

12. The non-transcient computer readable storage medium of claim 10 wherein the haptic contact signal backward is a specific gesture performed on the display.

13. The non-transcient computer readable storage medium of claim 10 wherein the haptic contact signal play is a specific touch gesture performed on the display.

14. The non-transcient computer readable storage medium of claim 10 further comprising executable instructions to load a multimedia object on the display and establish association with the chosen said frame.

15. The non-transcient computer readable storage medium of claim 10, further comprising executable instructions to store the position, size, rotational angle of the multimedia object relative to the frame, into the frame array.

16. The non-transcient computer readable storage medium of claim 14, wherein the multimedia object inserted is an animation.

17. The non-transcient computer readable storage medium of claim 14, wherein the multimedia object inserted is a sticker image.

18. The non-transcient computer readable storage medium of claim 14, wherein the multimedia object inserted is a text.

19. The non-transcient computer readable storage medium of claim 14, wherein the multimedia object inserted is a sound file.

20. The non-transcient computer readable storage medium of claim 10, further comprising executable instructions to store the multimedia object and the said frame into a Frame Array.

21. The non-transcient computer readable storage medium of claim 10, further comprising executable instructions to play the frames from the frame array, and display the said multimedia objects associated with the said frame, when the said frame is being played.
